(19) United States
(12) Patent Application Publication
(10) Pub. No.: US 2005/0099109 A1
(43) Pub. Date: May 12, 2005

(54) Fluorescent lamp

(75) Inventor: Shing Cheung Chow, New Territories (HK)

Correspondence Address: KAPLAN & GILMAN , L.L.P., 900 ROUTE 9 NORTH, WOODBRIDGE, NJ, 07095, US

(73) Assignee: Lap Lee Chow

(21) Appl. No.: 10/999,043

(22) Filed: Nov. 29, 2004

Related U.S. Application Data
(63) Continuation-in-part of application No. 10/331,675, filed on Dec. 27, 2002, now Pat. No. 6,836,065.

(51) Int. Cl. H01J 1/62; H01J 63/04

(52) U.S. Cl. 313/485

(57) ABSTRACT

The invention relates to a fluorescent lamp having a transparent or translucent glass bulb of a tubular cross section containing an inert gas such as Neon, Argon, Krypton or Xenon. A means to produce an electric discharge within said bulb will energise a coating of a fluorescent material deposited on the interior surface of the glass bulb in an arbitrary pattern to emit a novelty style visible light.

### CROSS REFERENCE TO RELATED APPLICATIONS

This application is a continuation-in-part application to U.S. patent application Ser. No. 10/331,675, filed Dec. 27, 2002, entitled “Fluorescent Lamp,” the entire disclosure of which is hereby incorporated by reference.

### FIELD OF INVENTION

The present invention relates to a fluorescent lamp and related mounting which for example but not exclusively allows for novelty lighting patterns.

### BACKGROUND

Fluorescent lamps have been in use for many years primarily to provide light in dwellings and the like. Fluorescent lamps comprise of a tubular bulb with a fluorescent material coated on the interior surface. The bulb typically contains an inert gas such as Neon, Argon, Krypton or Xenon and electrodes. When the electrodes are energised, a flow of electric current passes through the inert gas. During the discharge, the inert gas emits several wavelengths of light including ultraviolet light. The ultraviolet light strikes and excites the fluorescent material coating within the tube. The fluorescent material coating, when excited, emits a particular colour of visible light according to the fluorescent material chosen. Sometimes a small amount of mercury is added to the lamp in order to generate more intense ultraviolet light and hence to increase the intensity of the light emitted from the fluorescent material coating.

The manufacture of fluorescent tubes is known in the art by a number of methods. For example in United Kingdom Patent No. 639330 it is known to either flow or spray a fine divided powder in lacquer which is then drained and dried or baked. In U.S. Pat. No. 2,151,496 a particular admixture or transparent matrix which can be applied to the inner surface of the lamp is described for applying the fluorescent coating. U.S. Pat. No. 3,067,356 discloses a method of baking to remove the binder and/or any molecules of gas absorbed on the glass and the phosphorous surface.

In U.S. Pat. No. 2,896,187 the installation of electrodes to the lamp is described. In U.S. Pat. No. 2,386,277 the process of removing the waste gas and introducing the inert gas is described.

Standard fluorescent tubes which are used in the lighting of commercial or domestic premises consist of a tube where the fluorescent material coating is applied substantially over the entire length of the tube. The fluorescent material chosen normally emits a white or off white colour so that such a tube can efficiently illuminate a room. The light emitted is visible light. Such fluorescent tubes are purely functional and do not provide a visually appealing effect other than to illuminate a room. Fluorescent lighting tubes are produced to maximise the light that is emitted from them and hence having openings within the fluorescent material coating is generally not desirable. Furthermore since the light is of a bright intensity, fluorescent tubes used for domestic or commercial lighting purposes would hence not easily lend themselves to providing a novel visually appealing effect by the pattern application of the fluorescent material. The white and hence bright intensity of light emitted from such tubes would be too strong for a person to be able to distinguish and observe any patterned configuration of light emission. They are also not able to be used in handheld applications.

Fluorescent lamps such as those described in U.S. Pat. No. 5,565,685 and U.S. Pat. No. 5,557,112 have a tube which has a fluorescent material coating coated only in certain parts of the tube. In U.S. Pat. No. 5,557,112 for example, different zones are coated with a material so that a different radiation characteristic can be provided along the length of the tube. The tubes described in these two US patents have applications other than those for providing visible light to be viewed by a person or to appeal to the eyes of a person. The tubes described in these two US patent specifications emit an ultra violet light which is not visible to the naked eye hence a person would not be able to utilise the fluorescent tubes of U.S. Pat. No. 5,565,685 and U.S. Pat. No. 5,557,112 for the purposes of achieving a novelty effect.

### SUMMARY OF THE INVENTION

It is therefore an object of the present invention to provide a fluorescent lamp and related mounting which can create a visible novelty and appealing effect or which will at least provide the public with a useful choice.

Accordingly, in a first aspect the present invention may broadly be said to consist of a method of producing a fluorescent lamp having an interior and an exterior comprising the steps of
arbitrarily applying a novelty pattern of fluorescent coating to the interior of the lamp,
connecting electrodes to the interior and sealing the lamp, and
replacing the interior with inert gas.

Preferably said method further comprising the step of preparing a drawing tool to apply an admixture to said interior.

Preferably said method further comprising the step of preparing an admixture and applying said admixture to said drawing tool.

Preferably said drawing tool comprising a bent elongated member with an acute tip configured to apply dots of admixture.

Preferably said drawing tool comprising a bent capillary tube having two ends and an ejecting reservoir at one end communicating through said tube to an outlet at the opposite end.

Preferably said drawing tool receives a source of pressurised air, and a source of admixture, said air and admixture being combined to eject a spray from said tool.

Preferably said admixture is prepared using at least nitration cotton, fluorescent powder, glass adhesive and a solvent.

Preferably said method further comprising said step of preparing a glass bulb having an interior and an opening configured to receive said drawing tool.

Preferably said method further comprising said step of preparing a glass tube and connecting said bulb and said tube together.

Preferably said method further comprising the step of connecting an electrode on said interior of said lamp.

Preferably said method further comprising the step of sealing the said interior.

Preferably said method further comprising the step of evacuating waste gases from said sealed interior.

Preferably said method further comprising the step of filling said evacuated interior with inert gas.

Preferably said method further comprising the stages of spraying a conductive film on said exterior position of said lamp.

Preferably said method further comprising the step of attaching a triggering electrode to said conducting film and locking said lamp.

Preferably said method further comprising the step of ageing said lamp.

In a second aspect the present invention consists of a fluorescent lamp produced according to the method as described above.

In a third aspect the present invention consists in a fluorescent lamp for creating a novelty light pattern comprising
a) a transparent or translucent glass bulb containing an inert gas such as Neon, Argon, Krypton or Xenon,
b) means to produce an electric discharge within said bulb,
c) a coating of a fluorescent material deposited in an arbitrary pattern on the interior surface of said glass bulb to emit visible light upon energisation of said means to produce electric discharge
wherein said means to produce electric discharge is energised, a novelty pattern of visible light is emitted by said fluorescent material and no visible light is emitted by any region uncoated.

Preferably regions of the interior surface of said bulb where said coating is present will emit upon energisations, a visible light and said at least one region uncoated of the interior surface of said bulb will emit no light, but will allow light to pass there through.

Preferably said glass bulb is of an elongate nature and has a first distal end which includes a region for mounting said glass bulb with a means to mount.

Preferably said region for mounting includes a driving region at which a means to drive of said means to mount is able to engage and to rotationally drive said glass bulb.

Preferably said driving region is cylindrical in shape and coaxial with the circular cross section of the first distal end of said glass bulb.

Preferably said glass bulb is of a substantially constant circular cross section.

Preferably said means to produce a discharge is a pair of electrodes.

Preferably a first of said pair of electrodes is provided at the first distal end of said glass bulb and a second of said electrodes is a film applied onto the exterior of said glass bulb and is energized via a lead engaged to said film proximate to said first distal end.

Preferably said pair of electrodes are provided at opposite ends of said glass bulb and both said ends of said glass bulb are supported by a means to mount.

Preferably said glass bulb is of an elongate nature and extends at least in part linearly from its first end.

Preferably said glass bulb is of an elongate nature and extends substantially linearly from its first end save for a curved region thereof at said second distal end.

Preferably a second distal end has engaged thereto a non tubular section.

Preferably said non tubular section is bulbous.

Preferably a second distal end is of a curved but tubular nature and defines a loop shaped end to said glass bulb.

Preferably said glass bulb is straight.

Preferably said method further comprising a glass plate within said lamp having a novelty pattern of fluorescent material applied thereto.

In a fourth aspect the present invention consists of a lighting fixture for providing a novelty lighting effect said lighting fixture comprising a fluorescent lamp and a means to mount, said means to mount including a receiving region with which said fluorescent lamp is snugly engaged by or at its first distal end thereof, said receiving region rotatable by a means to rotate said lamp about an axis coaxial with the longitudinal direction of said lamp.

Preferably said means to mount is portable and includes a handheld housing which includes said means to energise.

Preferably said means to mount includes a brush remaining stationary with the housing of said means to mount and enagagble against the film defining said second electrode and via which energisation of film can occur.

In a fifth aspect the present invention consists of a drawing tool for applying a novelty pattern to an interior of a fluorescent lamp comprising:
an elongate member having a handle portion and an application portion, said handle portion being it a significant angle to said handle portion;
an acute application tip configured to receive an admixture to apply to an interior of a fluorescent lamp.

Preferably said method further comprising a drawing tool for applying a novelty pattern to interior of a fluorescent lamp comprising:
a capillary tube having a handle portion and an application portion, end portion having an end said handle portion being a significant angle to said handle portion, an ejecting reservoir at a first end communicating through said tube to an outlet at a second end.

Preferably said method further comprising a drawing tool for applying a novelty pattern to an interior of a fluorescent lamp comprising an elongate member having a handle portion and an application portion, said handle portion being a significant angle to said handle portion, and
an outlet in said application portion combining a source of pressurized air and a source of admixture to form a spray to apply to an interior of a fluorescent lamp.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

One preferred form of the present invention will now be described with reference to the accompanying drawings in which;

FIG. 1A is a side view of a fluorescent lamp of the present invention without any patterned fluorescent material shown,

FIG. 1B is a view of a fluorescent lamp of the present invention to illustrate the manner in which energisation of the gases within the tube can occur by the provision of electrodes located at or proximate to one end only of the lamp,

FIG. 2 is a side view of a fluorescent lamp wherein two different styles of patterns have been formed by the provision of openings in the fluorescent material layer coated on the interior surface of the tube,

FIG. 3-6 show alternative patterns,

FIG. 7 illustrates a fluorescent lamp where the second end has been formed to provide a tube which is partially straight and partially curved, and

FIG. 8 shows an example of tube mounted with a mounting,

FIG. 9A is an interior view of an example of a mounting wherein a first end of the fluorescent tube is engaged with the mounting and wherein a means to rotate is provided to allow for the fluorescent lamp to rotate relative to the mounting,

FIG. 9B is an exploded perspective view of an example of a rotation mechanism wherein a brush-like contact is provided to the transparent conducting film coating provided on the exterior of the bulb,

FIG. 9C is an alternative arrangement for rotary motion,

FIG. 10 is a side view of the bulb shaped present invention,

FIG. 11 is a side view of the T shaped present invention,

FIG. 12 is a side view of the tube shaped present invention,

FIG. 13 is a block diagram of painting or wiping the admixture,

FIG. 14 is a block diagram of spraying the admixture,

FIG. 15 is a tube with an internal glass plate with a base coating, and a hand painted pattern,

FIG. 16 is a bulb with a sprayed novelty pattern,

FIG. 17 is a tube with a base coating and a sprayed novelty pattern,

FIG. 18 is a T shaped tube with a base coating and a painted novelty pattern,

FIG. 19 is a flow diagram of manufacturing process,

FIG. 20 is a flow diagram of admixture preparation,

FIG. 21 is an example system for removing waste gases,

FIG. 22 is an example tool for dotting,

FIG. 23 is an example tool for writing,

FIG. 24 is an example tool for spraying,

FIG. 25 is examples of the different angles and of drawing tools.

### DETAILED DESCRIPTION OF THE INVENTION

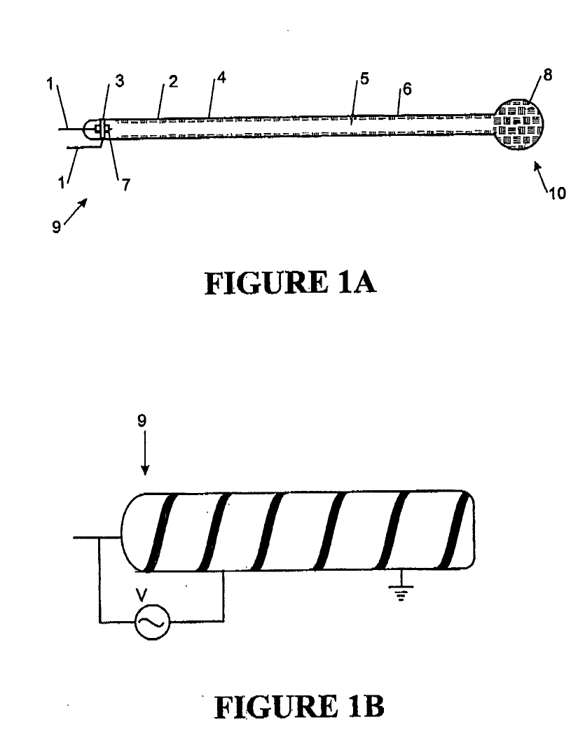

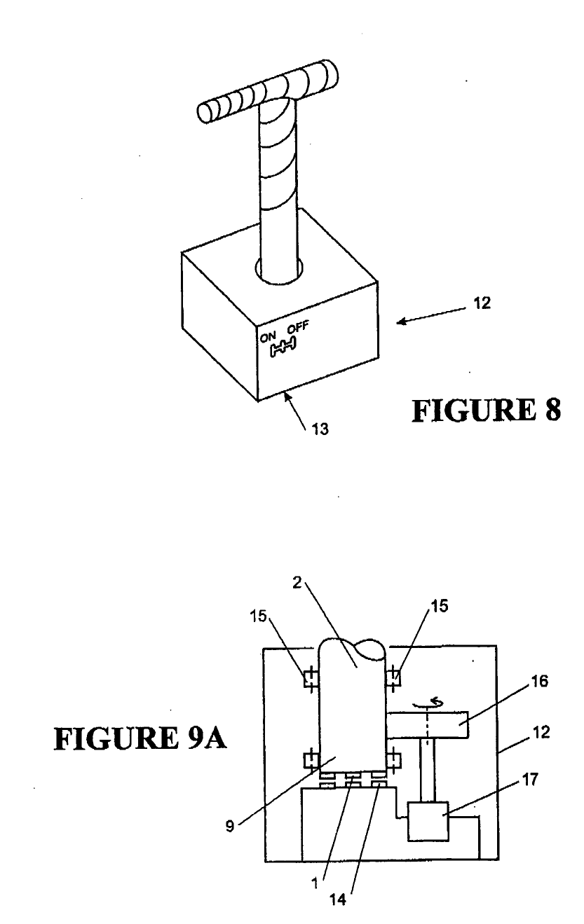

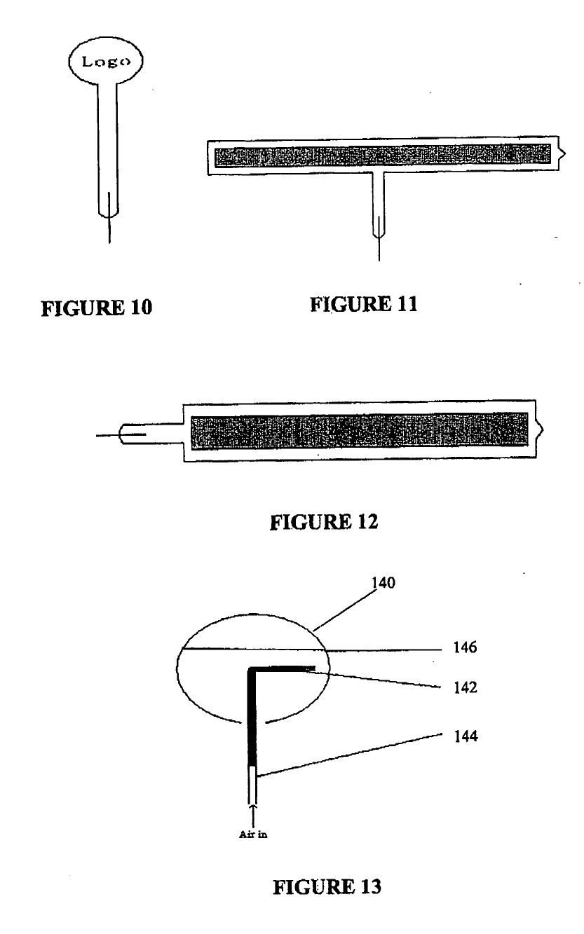

The present invention comprises a fluorescent lamp as for example shown in FIG. 1A. The fluorescent lamp includes a tube 2 preferably made of glass and which is preferably of a cylindrical shape and substantially of constant cross section. The tube 2 may have at one of its ends a non-constant cross section extension such as for example the bulbous extension 8 as shown in FIG. 1A, other shapes as shown in FIG. 8 ball shaped seen in FIG. 10 or T shaped and seen in FIG. 11. Such an extension may be of glass and blown as part of the same material as the glass tube 2, or it may have been engaged to the glass tube 2 after the glass tube 2 has been formed. The glass tube 2 is sealed to the exterior and contains an inert gas such as, for example, Neon, Argon, Krypton or Xenon. Mercury can optionally be added to increase the amount of ultraviolet light if desired; however mercury is not necessary for this invention to work. The glass tube 2 has a first end 9 where at least one and preferably both electrode terminals 1 are provided. The electrode terminals 1 are provided in a manner so that these can be engaged to a power source such as one derived from a battery. The terminals 1 are preferably provided at or proximate to the first end 9 however one of the terminals may alternatively be provided at the second end 10 of the tube. The preferred form is shown in FIG. 1B where two electrode terminals are close to end 9.

Process of Manufacturing

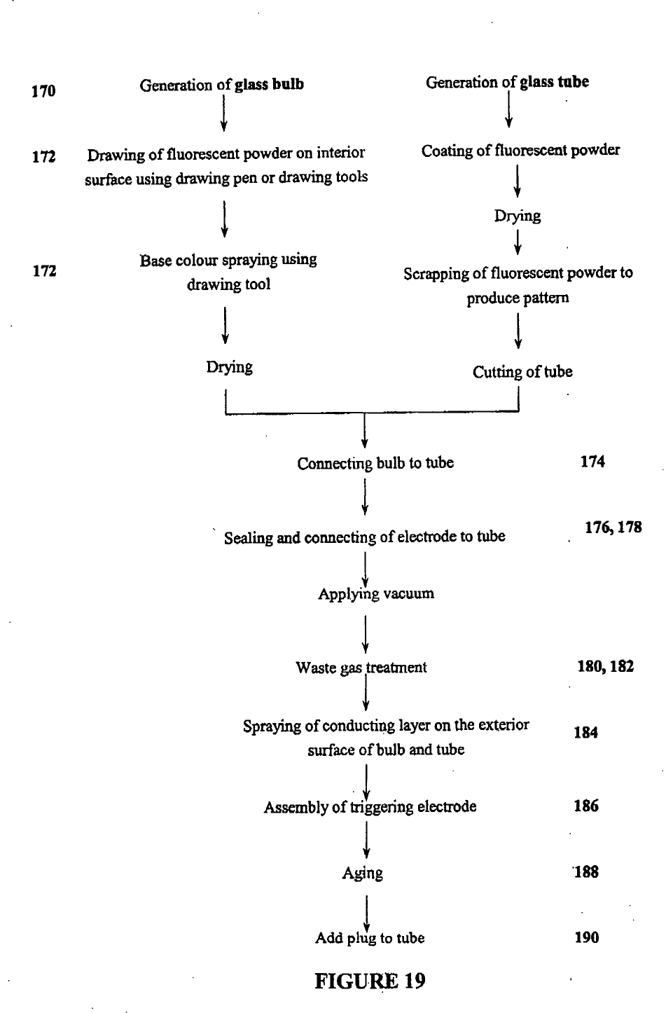

The process of manufacturing seen in FIG. 19 involves the following steps:
(a) preparing the glass bulb and tube 170
(b) applying a fluorescent powder coating on the interior glass surface 172
(c) connecting the bulb and the tube together 174
(d) connecting of electrode to the tube 176
(e) sealing the tube 178
(f) waste gas removal 180
(g) filling the tube with inert gases 182
(h) spraying of conducting film on exterior glass surface (if the conducting film is the other electrode) 184
(i) assembly of triggering electrode 186
(j) aging 188 and
(k) adding a plug [adapter] to the product 190.
   A. Preparing Glass and Tube

Glass is heated in a flame to soften it, and after the glass is softened, air is blown in to produce a glass bulb or tube.

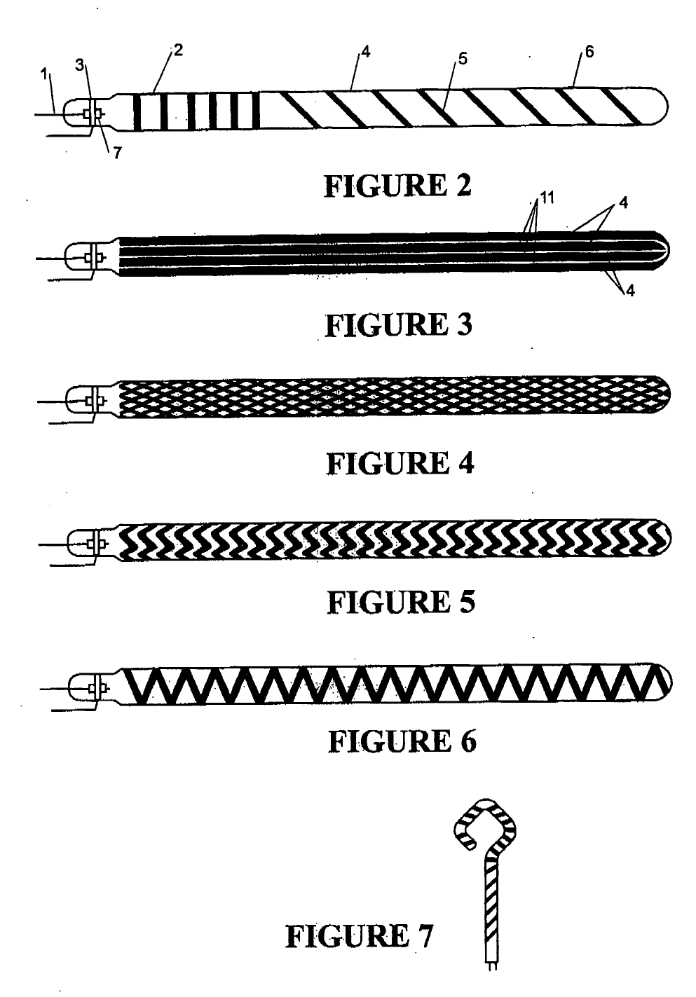

The lamp may have a second end 10 which has a shape which deviates from the straight tubular nature as shown in FIGS. 2-6. For example, with reference to FIG. 7, the second distal end 10 has been curved and such a curve can in an abstract sense be made to simulate the flame of a candle for example. This is shown in FIG. 7. It will hence be appreciated that the fluorescent lamp of the present invention can be used to provide a novelty product of many shapes and any patterned fluorescent material coating appealing to the eye.

B.1 Method of Applying and Removing Fluorescent Powder to Create a Pattern

The interior of the glass tube 2 is coated with a fluorescent material 4. The fluorescent material coating is preferably chosen such that it emits a colour or colours other than white. To provide a novel viewing effect, the fluorescent material is preferably selected from those which emit vibrant colour. At least part of the interior of the glass tube 2 is coated with the fluorescent material. However there are also provided openings in the fluorescent material coating. The openings (which may alternatively be considered uncoated regions) create transparent regions in the glass tube and allows for the interior of the glass tube to be visible from the exterior. The interior of the lamp bounded by the glass tube is exposed to the exterior everywhere save for where the fluorescent material is applied to the interior of the tube.

With reference to FIG. 3, it can be seen that the fluorescent material 4 is applied save for at the openings 11. The multiple openings 11 shown in FIG. 3 extend substantially parallel and longitudinally along the interior surface of the glass tube. Although there may only be provided one opening, a plurality of openings have shown to be provided in at least FIG. 3, 4 and 5. When the electrodes are energised, and internal inert gas of the glass tube discharges to emit ultraviolet light, the fluorescent material 4 will be excited to emit visible light of a certain colour. At the openings, the visible light emitted through the glass tube will be from the fluorescent material coating on the far side interior surface of the tube. As can be seen in FIGS. 1-6, the glass tube is preferably of an elongate nature and substantially of a constant cross-sectional shape.

With reference to FIGS. 3, 4 and 6, the opening(s) are longitudinal in nature and extend in the longitudinal direction. With reference to FIGS. 4 and 6, the opening(s) may also have a component of direction which is tangential.

FIGS. 4 and 6 illustrate a spiralling pattern that is generated by the provision of the opening.

FIG. 6 illustrates a glass tube wherein a single opening has been provided which runs the entire length and spirals the entire length of the glass tube.

In FIG. 4, multiple openings are provided which spiral the length of the tube to provide a similar but more dense spiralled effect.

The openings in FIG. 5 do not extend longitudinally but instead define discrete rings which are, for example, of a wave like shape. In fact any desired patterned effect can be created.

The openings may be created by the scraping away of fluorescent material which has been coated to the interior surface of the glass tube. Such scraping can occur whilst at least one of the ends of the glass tube is open. A tool can be inserted into the glass tube and the tool can be moved relative to the glass tube to scrape away the fluorescent material to create the opening(s). Alternatively the fluorescent material may be pattern applied by for example the use of a mask.

The opening or openings provided in the fluorescent material coating create a patterned appearance of the fluorescent material coating. The patterned appearance is preferably of a repeating kind. With reference to FIG. 2, the openings through the fluorescent material coating may create more than one kind of pattern. It is also possible that regions of different coloured fluorescent material coating are provided to the interior surface of the tube. Such may be provided by connecting two tubes together which have each been individually coated with a different coloured fluorescent material coating. The openings in such a multi coloured configuration may have been created by removing the fluorescent material coating prior to the tubes being connected together or after the tubes having been connected together.

With provision of the openings in the fluorescent material coating, when the tube is moved, the light which is emitted will further create a novelty viewing experience. The regions of the tube where fluorescent material is provided, will emit “foreground” visible light, i.e., visible light emitted from the near side fluorescent material coating and the regions where the openings are provided will emit “background” visible light, i.e., visible light emitted from the fluorescent material coating provided on the far side of the interior surface of the glass tube. Light from the fluorescent material coating on the opposite side of the tube to where an opening is provided, can be transmitted through the opening. The light from the fluorescent material coating on the opposite side of the tube to where an opening is provided, will pass through the opening and have a different quality or brightness from the light which is transmitted from the fluorescent material coating adjacent the opening and on the same side of the opening of the tube. A 3-D viewing effect will thus be experienced by a viewer.

B.2 Method of Drawing Fluorescent Powder on the Interior Surface to Create a Novelty Pattern.

The fluorescent powder may be “drawn” or deposited on the interior surface of the tube to create an eye-catching effect. The fluorescent powder can also be “drawn” on a plate (glass, plastic or metallic) located within the tube enclosure. The word/pattern/logo drawn on the interior glass surface (for the ball or other shaped structure) or on the plate inside the tube (for T-shaped and tubular structure) will light up when the tube is energised. Such a plate would be made of approximately 1 mm in thickness and is made of glass. Fluorescent powder admixture is applied to the surface of the glass plate so that words or patterns can be drawn by hand (for small-scale production) or printed (for mass production) onto the plate. The plate is then inserted into the glass tube through an end of the tube (other than the end where the electrode is connected). After the waste gas treatment and the inert gas filling, the glass tube is sealed at the said end of the tube. Fluorescent powder can be “drawn” on another layer of fluorescent powder serving as a colored background. The pattern to be drawn on the plate in the T-shaped or tubular structure can be printed by using common printing technique with the fluorescent powder admixture. This permits large-scale production.

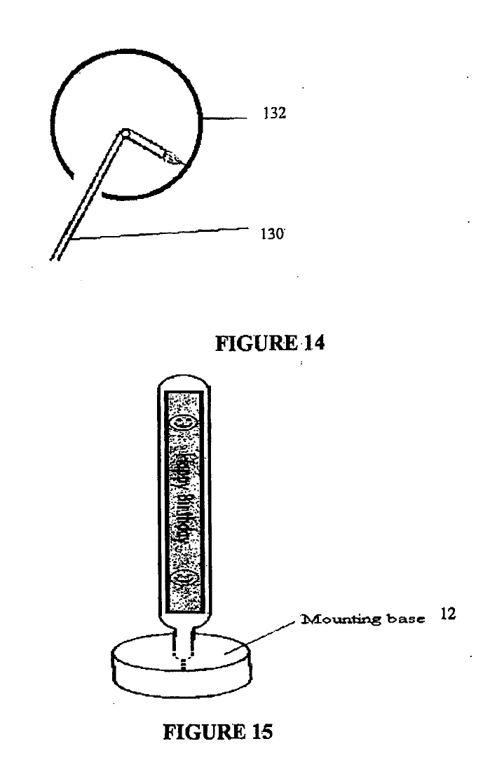

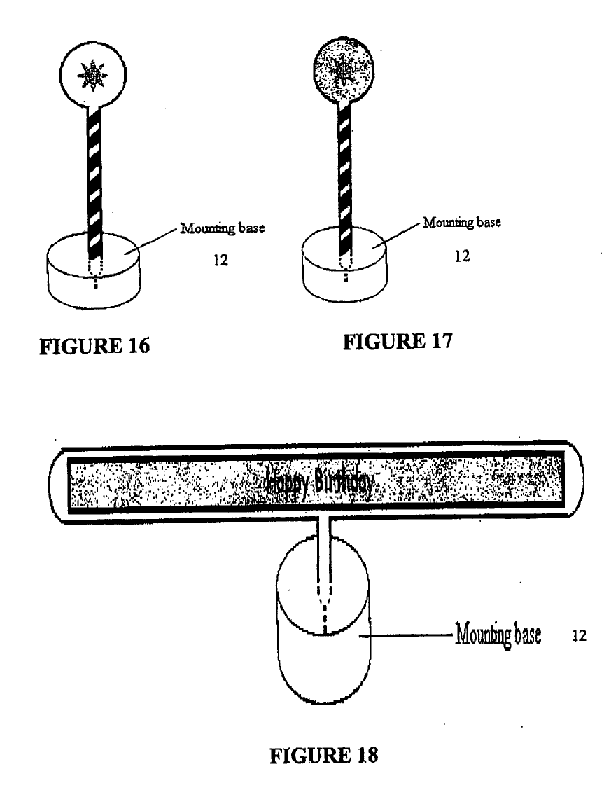

The Applicant has several possible methods of drawing as examples, although one skilled in the art will contemplate a number of methods are possible.
1. Staining/drawing the admixture with a drawing pen brush seen in FIG. 14. First, the required drawings and/or words are drawn on a piece of paper as a reference. Then, the painter puts a drawing pen dipped 130 with the fluorescent powder admixture inside the glass bulb 132 and draws accordingly. The drawing pen brush may have an adjustable angle joint and/or an arm of adjustable length.
2. Solution ejection method with a drawing tool seen in FIG. 13 includes a glass bulb with an opening 140, where some of an admixture 142 is drawn into a drawing tool (a bent glass tube is one example) 144. Then a small amount of admixture 142 is sprayed or ejected to the interior surface 146. The solvent is later removed by warming and baking, and the nitration cotton decomposes and binds the fluorescent powder to the glass surface 146.
3. An appropriate grid covering the desired pattern is added in proportion to the size of the glass bulb. Some black dots are added on the external surface of the glass bulb over the grid, to act as drawing reference points. Drawing can then be made on the interior surface of the glass bulb according to the reference points by using an appropriate apparatus containing fluorescent powder admixture.

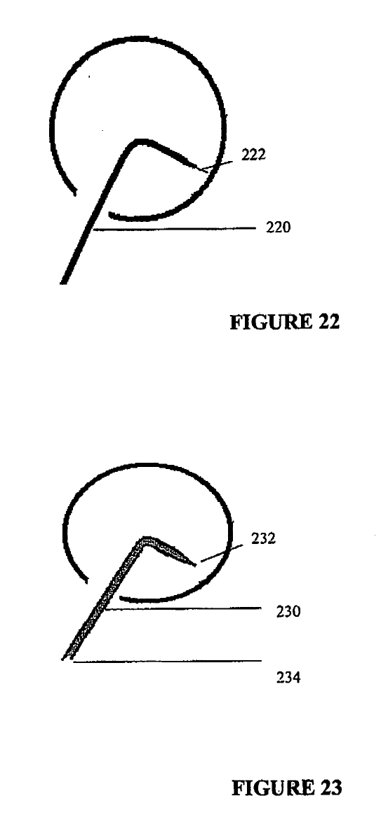

For dotting a bent glass rod 220 or metal wire with a sharp tip 222 stained with admixture can be used as seen in FIG. 22. This method is applicable for small area application.

The fluorescent powder admixture on the sharp tip can be replenished by putting it into the admixture source.

This method of application is simply due to the mechanical contact between the interior glass surfaces with the rod or wire tip.

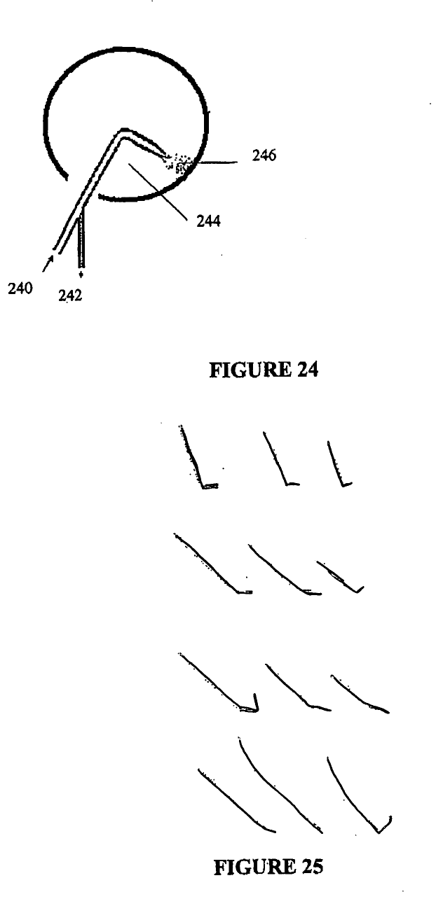

For writing, a bent capillary tube 230 filled with fluorescent powder admixture inside can be used as shown in FIG. 23. The tube 230 is connected to a dropper head 234 which allows tiny drop of the admixture to be ejected via the tip 232 from the tube 230. This method is applicable for line drawing, including writing.

A small amount of the fluorescent powder admixture can be ejected out from the capillary tube upon compressing the dropper.

A set of capillary tubes with different bent angles can be used so to allow drawing in different parts of the glass bulb as shown in FIG. 25.

Alternatively flexible plastic material which provides force for ejection can be replaced by a gas syringe.

Preferably the thickness of the fluorescent powder solution coating is 0.1 mm to 0.3 mm.

For spraying an air pump 240 can be used to draw admixture 242 into a tube 244 which creates a mist at the outlet 246 to spray into the bulb as seen in FIG. 24. This method is applicable for applying the base colour to the glass bulb.

Small amount of fluorescent powder admixture is carried by the air flow. The fast air flow breaks the admixture (in solution) into fine droplets and carried by the air flow to give a mist of fluorescent powder.

By way of example the composition of the admixture 2 could be:
1-5% Nitration cotton
25-30% Fluorescent powder
0.5-2.5% Glass adhesive
n-Butyl acetate as solvent.

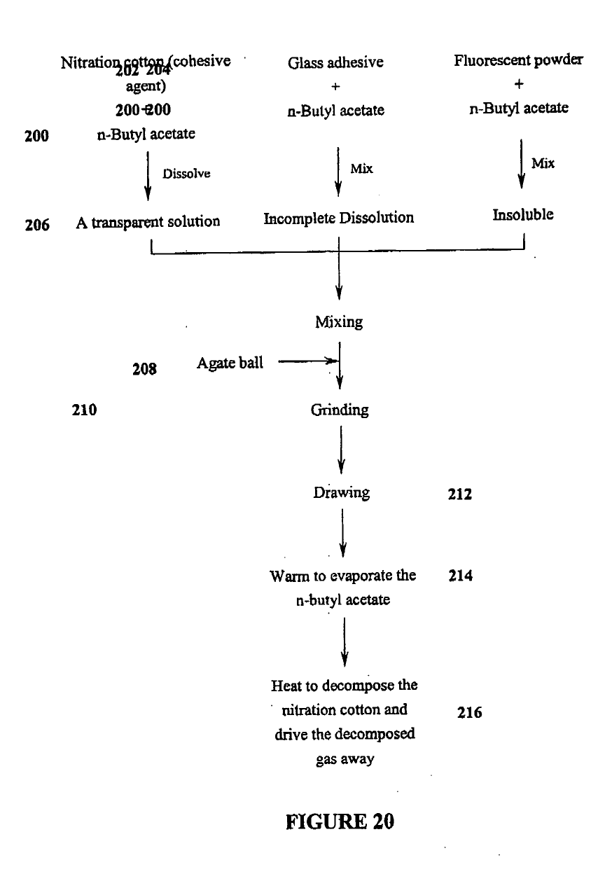

Such an admixture can be prepared in one example according to FIG. 20:
1. Nitration cotton, a cohesive agent, may be dissolved in n-butyl acetate solvent 200.
2. Glass adhesive 202 and fluorescent powder 204 may be separately mixed with n-butyl acetate to give two admixtures.
3. The nitration cotton solution is mixed 206 with the two admixtures. Agate balls 208 may be added to the admixture and the admixture is “grinded” 210 (to make the suspended particles more fine) with a grinding machine for more than 24 hours to make the admixture finely mixed.
4. The final admixture can then be used to draw 212.
5. After drawing is finished, the glass ball is warmed 214 under a ventilated flow of warm air and then may be dried 216 at a high temperature (480-580° C.) medium. In the warming process, n-butyl acetate is vapourized and removed with the flow of warm air. Nitration cotton adheres the fluorescent powder and the glass adhesive to the interior surface of the glass ball. Upon baking under high temperature, the glass adhesive firmly holds the fluorescent powders together to give a coating and firmly adheres the fluorescent coating to the interior glass surface. At the same time, nitration cotton is decomposed and vapourizes in baking. Therefore, the fluorescent coating will not easily come off from the inner glass surface during operation of the eye-catching “lamp”.

In a further example of preparation of the fluorescent powder admixture the contents of U.S. Pat. No. 639,330, U.S. Pat. No. 2,151,496, and U.S. Pat. No. 3,067,356, are all incorporated herein by reference.

C. Connecting the Bulb and Tube

The glass bulb and the glass tube are connected together by
(a) melting the glass around the opening of the bulb and the opening of the tube through flame heating,
(b) joining the two openings together, and
(c) having the molten glass solidified when it has cooled down.
   D. Connecting of Electrodes to the Tube

There are two electrodes. One is connected to the tube interior and the other (the triggering electrode) is connected to the exterior surface. Therefore, the electrodes are assembled in two different steps in the manufacturing process. In relation to connecting of electrodes to the tube interior the contents of U.S. Pat. No. 2,896,187, are incorporated herein by reference.

E. Sealing the Tube

An electrode and a glass pellet are placed inside the tube. After the waste gas treatment and the inert gas filling, the glass tube is sealed at the end of the tube. Heat is then applied to the tube where the electrode is located. Since the glass pellet melts upon heating, the glass melt helps to affix the electrode to the tube. Then, the tube is cut at the place where heat is applied to melt the glass pellet. Thus part of the electrode will be exposed to the surroundings after this step.

F. Waste Gas Treatment

Removal of the waste gases (e.g. the vaporized n-butyl acetate and the air inside the tube). The configuration of the electrodes for discharging the inert gas can be both provided from the first end 9 and reference is hereby made to U.S. Pat. No. 4,471,350. U.S. Pat. No. 4,471,350 describes a fluorescent tube of a kind which may be utilised for the purposes of the present invention. The entire contents of U.S. Pat. No. 4,471,350 and U.S. Pat. No. 2,386,277 are hereby incorporated by way of reference.

G. Inert Gas Filling

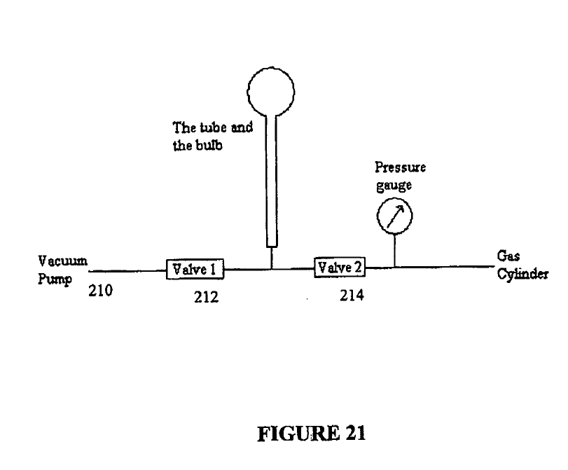

Filling the tube with required inert gas (e.g. Xenon or Krypton) optionally with mercury, can be done using the setup shown as FIG. 21.

The waste gas can be removed by the vacuum pump 210. First Valve 212 opens and second valve 214 closes. The tube is filled with inert gas to attain a pressure of 10-100 mmHg. First Valve 212 closes and second valve 214 opens.

H. Conductive Film Electrode

Item 6 on FIG. 1A is directed towards the conductive film provided on the exterior of the tube. Conductor 3 connects this conductive film to the power source through one of the terminals 1. The steps involved in applying a conductive film to the exterior of the glass tube are as follows: (1) Heat the glass tube; (2) Spray SnCl₄ (tin (IV) chloride) onto the exterior surface of the glass tube. SnCl₄ will react with O₂ (Oxygen) in the air to produce SnO₂ (tin dioxide) and Cl₂ (chlorine). SnO₂ is the conductive material (in solid form) which will stick on the exterior surface of the glass tube firmly to become a conductive film.

I. Triggering Electrode Connected to Conductive Film

A conductive film is sprayed on the exterior surface of the tube. A T-shaped nickel electrode is then connected to the conductive film. A conducting metal paste is added and the tube is baked in an oven at a temperature of 200-300° C.

J. Aging

The aging process involves lighting up the fluorescent tube for a certain period so as to make the invention more stable in performance.

Mounting

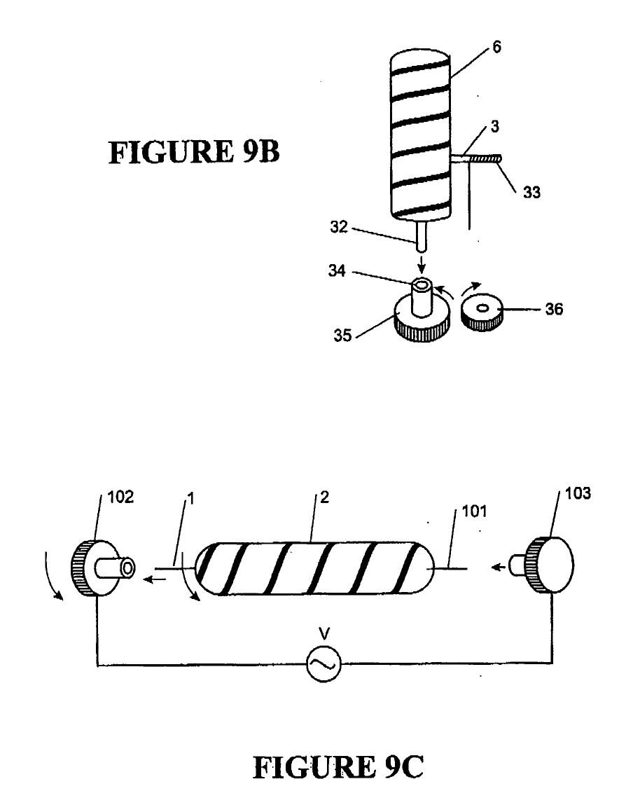

The fluorescent lamp of the present invention may be mounted to a mounting 12 as shown in FIG. 8. Mounting for the lamp may occur at only one of its ends. The first end 9 may for example be inserted into a receiving region of the mounting 12. The mounting 12 may include an appropriate connection to a power source such as a battery so that energisation of the electrodes and discharge of the inert gas within the tube can occur. The mounting may hence be self contained and may also include an on and off switch 13. The fluorescent lamp may be mounted with the mounting 12 in a manner to be removable therefrom. In the form where the lamp is mounted from one end only, the lamp includes an electrode 32 which extends into the interior of the lamp and a transparent conducting film coated on the exterior surface of the tube. With reference to FIG. 9B, the second electrode 3 is in contact with the exterior surface of the tube thereby providing a conducting path for the electricity conducted via the transparent conducting film. The electrode 32 may remain stationary whilst the tube rotates and a spring 33 may be provided to bias the electrode 3 against the exterior surface of the tube. The electrode 32 can insert into an opening 34 of a driving gear 35 wherein the driving gear itself can be made of a conducting material. A second gear 36 may provide the insulation required to isolate the flow of electricity from the gear 35.

In an alternative configuration as shown in FIG. 9C, the lamp is mounted at two ends. The lamp includes a first electrode 1 and a second electrode 101 at the respective ends of the tube 2 each extending into the interior of the lamp. Each of the two electrodes inserts into an opening of a gear. The electrodes are connected to a power source through an appropriate connection such as through the gears to which they are connected which can be made of a conducting material. A driving gear 102 rotates the tube through the coupling of the gear with the first electrode 1. The other gear 103 rotates in concert with the driving gear 102 through a gear system which is not shown in FIG. 9C but can be one commonly known in the art.

Fluorescent lamps of different configurations or colours may for example be interchanged and mounted with the mounting means. Where the fluorescent lamps are designed to be used in entertainment or concert like situations, the mounting 12 is preferably of a size sufficiently small to be carried in or by the hand of a person. Likewise the fluorescent lamp to engage with such a mounting is of a size which is not too large. The fluorescent lamp may for example be of a length of between 1 and 100 cm and of a diameter between 0.15 and 1.5 cm.

The fluorescent material is chosen such that the light emitted is within the visible range of say between 350 nm to 750 nm.

The mounting 12 and the fluorescent lamp may alternatively be of a larger size and may be designed to simulate the barber shop spiral, traditionally associated with barber shops.

The fluorescent lamp in such an application may again be mounted only at one end, or alternatively at both ends. In both the barber shop application and in the concert/festive situations, it may be desirable that the fluorescent lamp is rotated relative to the mounting 12. With reference to FIG. 9, there is shown a basic layout of the interior of a mounting 12 within which the tube 2 has been engaged at its end 9. The terminals 1 of the tube are engaged with complementary terminals 14 of the mounting 12. The tube 2 is mounted so that it is rotatable relative to the housing. Rotatable bearing surfaces 15 may for example be provided in between which the tube 2 can snugly locate and be supported thereby in a rotational manner. A means rotatable such as a drive wheel 16 which is driven by an electric motor 17 can engage with the exterior surface of the tube 2. The electric motor when it is rotated, will rotate the drive wheel 16 which through friction or through a toothed or belt drive engagement with the tube, will rotate the tube about its longitudinal axis.

Power Source

The lamp as shown in FIG. 1B is energised by an AC power source. Where DC batteries are provided there would be a DC to AC inverter providing an AC voltage from approximately 200 volts to approximately 2000 volts at a frequency over 1 kHz from battery voltages of 3 volts to 6 volts DC. The exterior surface conducting film is of substantially the same voltage as the earth. The voltage at the electrode extending into the interior of the tube will vary according to the AC voltage. Because the exterior surface conducting film is substantially at earth, a person touching the exterior surface of the glass tube will not give rise to an electric shock. Under normal circumstances and proper functioning even if the high voltage electrode is touched, the current generated will be very small and will not be hazardous to the health since the resistance of the glass is very high.

Automated Methods

It would be appreciated that in the foregoing while manual methods have been described one skilled in the art could equally devise a method of automatically depositing a novelty patterns without inventive input. For example, all of the tools described herein could equally be coupled to a mechanical or robot actuator to deposit the novelty pattern. Such automated or computer aided methods do not depart from the scope of the present invention.

1. A method of producing a fluorescent lamp having an interior and an exterior comprising the steps of
arbitrarily applying a novelty pattern of fluorescent coating to the interior of the lamp,
connecting electrodes to the interior and sealing the lamp, and
replacing the interior with inert gas.

2. A method as claimed in claim 1 further comprising the step of preparing a drawing tool to apply an admixture to said interior.

3. A method as claimed in claim 2 further comprising the step of preparing an admixture and applying said admixture to said drawing tool.

4. A method as claimed in claim 3 wherein said drawing tool comprises a bent elongated member with an acute tip configured to apply dots of admixture.

5. A method as claimed in claim 3 wherein said drawing tool comprising a bent capillary tube having two ends and an ejecting reservoir at one end communicating through said tube to an outlet at the opposite end.

6. A method as claimed in claim 3 wherein said drawing tool receives a source of pressurised air, and a source of admixture, said air and admixture being combined to eject a spray from said tool.

7. A method as claimed in claim 3 wherein said admixture is prepared using at least nitration cotton, fluorescent powder, glass adhesive and a solvent.

8. A method as claimed in claim 2 further comprises the step of preparing a glass bulb having an interior and an opening configured to receive said drawing tool.

9. A method as claimed in claim 8 further comprising the step of preparing a glass tube and connecting said bulb and said tube together.

10. A method as claimed in claim 9 further comprising an electrode on said interior of said lamp.

11. A method as claimed in claim 10 further comprising sealing said interior.

12. A method as claimed in claim 11 further comprising the step of evacuating waste gases from said sealed interior.

13. A method as claimed in claim 12 further comprising the step of filling said evacuated interior with inert gas.

14. A method as claimed in claim 13 further comprising the stages of spraying a conductive film on said exterior position of said lamp.

15. A method as claimed in claim 14 further comprising the step of attaching a triggering electrode to said conducting film and locking said lamp.

16. A method as claimed in claim 15 further comprising the step of aging said lamp.

17. A fluorescent lamp produced according to the method as claimed in claim 1.

18. A fluorescent lamp for creating a novelty light pattern comprising
(a) a transparent or translucent glass bulb containing an inert gas such as Neon, Argon, Krypton or Xenon,
(b) means to produce an electric discharge within said bulb,
(c) a coating of a fluorescent material deposited in an arbitrary pattern on the interior surface of said glass bulb to emit visible light upon energisation of said means to produce electric discharge
wherein said means to produce electric discharge is energised, a novelty pattern of visible light is emitted by said fluorescent material and no visible light is emitted by any region uncoated.

19. A fluorescent lamp as claimed in claim 18 wherein regions of the interior surface of said bulb where said coating is present will emit upon energisations, a visible light and said at least one region uncoated of the interior surface of said bulb will emit no light, but will allow light to pass there through.

20. A fluorescent lamp as claimed in claim 18 wherein said glass bulb is of an elongate nature and has a first distal end which includes a region for mounting said glass bulb with a means to mount.

21. A fluorescent lamp as claimed in claim 20 wherein said region for mounting includes a driving region at which a means to drive of said means to mount is able to engage and to rotationally drive said glass bulb.

22. A fluorescent lamp as claimed in claim 21 wherein said driving region is cylindrical in shape and coaxial with the circular cross section of the first distal end of said glass bulb.

23. A fluorescent lamp as claimed in claim 20 wherein said glass bulb is of a substantially constant circular cross section.

24. A fluorescent lamp as claimed in claim 20 wherein said means to produce a discharge is a pair of electrodes.

25. A fluorescent lamp as claimed in claim 24 wherein a first of said pair of electrodes is provided at the first distal end of said glass bulb and a second of said electrodes is a film applied onto the exterior of said glass bulb and is energized via a lead engaged to said film proximate to said first distal end.

26. A fluorescent lamp as claimed in claim 25 wherein said pair of electrodes are provided at opposite ends of said glass bulb and both said ends of said glass bulb are supported by a means to mount.

27. A fluorescent lamp as claimed in claim 20 wherein said glass bulb is of an elongate nature and extends at least in part linearly from its first end.

28. A fluorescent lamp as claimed in claim 20 wherein said glass bulb is of an elongate nature and extends substantially linearly from its first end save for a curved region thereof at said second distal end.

29. A fluorescent lamp as claimed in claim 20 wherein a second distal end has engaged thereto a non tubular section.

30. A fluorescent lamp as claimed in claim 29 wherein said non tubular section is bulbous.

31. A fluorescent lamp as claimed in claim 20 wherein a second distal end is of a curved but tubular nature and defines a loop shaped end to said glass bulb.

32. A fluorescent lamp as claimed in claim 20 wherein said glass bulb is straight.

33. A fluorescent lamp as claimed in claim 18 further comprising a glass plate within said lamp having a novelty pattern of fluorescent material applied thereto.

34. A lighting fixture for providing a novelty lighting effect said lighting fixture comprising a fluorescent lamp as claimed in claim 20, and a means to mount, said means to mount including a receiving region with which said fluorescent lamp is snugly engaged by or at its first distal end thereof, said receiving region rotatable by a means to rotate said lamp about an axis coaxial with the longitudinal direction of said lamp.

35. A lighting fixture as claimed in claim 34 wherein said means to mount is portable and includes a handheld housing which includes said means to energise.

36. A lighting fixture as claimed in claim 35 wherein said means to mount includes a brush remaining stationary with the housing of said means to mount and enagagble against the film defining said second electrode and via which energisation of film can occur.

37. A drawing tool for applying a novelty pattern to an interior of a fluorescent lamp comprising:
an elongate member having a handle portion and an application portion, said handle portion being a significant angle to said handle portion;
an acute application tip configured to receive an admixture to apply to an interior of a fluorescent lamp.

38. A drawing tool for applying a novelty pattern to interior of a fluorescent lamp comprising:
a capillary tube having a handle portion and an application portion, end portion having an end said handle portion being a significant angle to said handle portion, an ejecting reservoir at a first end communicating through said tube to an outlet at a second end.

39. A drawing tool for applying a novelty pattern to an interior of a fluorescent lamp comprising an elongate member having a handle portion and an application portion, said handle portion being a significant angle to said handle portion, and
an outlet in said application portion combining a source of pressurized air and a source of admixture to form a spray to apply to an interior of a fluorescent lamp.
